(19) United States
(12) Patent Application Publication
(10) Pub. No.: US 2006/0256033 A1
(43) Pub. Date: Nov. 16, 2006

(54) Method and apparatus for displaying an image on at least two display panels

(76) Inventors: Victor Ga-Kui Chan, Richmond (CA); Raymond Chow, Richmond (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/128,546

(22) Filed: May 13, 2005

(51) Int. Cl. G09G 5/00

(52) U.S. Cl. 345/1.1

(57) ABSTRACT

An apparatus for displaying an image on at least two display panels serves as an interface between an image source and a display device having at least two display panels and includes a memory. One embodiment includes an image input module for storing first line portions in a first contiguous portion of the memory, and second line portions in a second contiguous portion of the memory, wherein the first and second memory portions are spaced apart by a third portion of the memory. In another embodiment, the apparatus includes a transfer module for transferring first line portions from a first contiguous portion of the memory for display on a first one of the display panels, and for transferring second line portions from a second contiguous portion of the memory for display on a second one of the display panels before reading the next line.

### FIELD OF THE INVENTION

The present invention relates to graphics display systems, and more particularly to a graphics controller for use in a graphics display system for displaying an image on at least two display panels.

### BACKGROUND

Graphics display systems, such as mobile telephones, typically employ a graphics controller as an interface between one or more providers of image data and a graphics display device such as an LCD panel or panels. In a mobile telephone, the providers of image data are typically a host, such as a CPU, and a camera. The host and camera transmit image data to the graphics controller for ultimate display. The host also transmits control data to both the graphics controller and the camera to control the operation of these devices.

The graphics controller provides various processing options for processing image data received from the host and camera. For example, the graphics controller may compress or decompress, e.g., JPEG encode or decode, incoming or outgoing image data, crop the image data, resize the image data, scale the image data, and color convert the image data according to one of a number of alternative color conversion schemes. All these image processing functions provided by the graphics controller are responsive to and may be directed by control data provided by the host.

The host also transmits control data for controlling the camera to the graphics controller, the graphics controller in turn programming the camera to send one or more frames of image data acquired by the camera to the graphics controller.

Image data from either a host or a camera are typically streamed to the graphics controller in a raster scan order, and are stored in an internal memory in the graphics controller in the same order. Thereafter, one or more “display pipes” transmit image data to the display device, particularly by fetching image data stored in the internal memory and writing the data to an internal interface with the display device. The data are fetched and written through the display pipes in the same raster scan order in which the data were stored.

Mobile telephones are increasingly being provided with multiple display panels. Where the display device includes two panels, typically one of the panels displays image data from a first provider of image data, while the other panel displays image data from a second provider of image data. For example, the camera typically produces a “snapshot” image which is displayed on one panel, while the host typically provides a graphics image, e.g., a host created menu of options for operating the mobile telephone. In mobile telephones with two displays configured in this manner, typically one portion of the internal memory is partitioned as a frame buffer for storing frames of image data received from one source of image data and corresponding to one image, and another portion of the internal memory is partitioned as a frame buffer for storing separate frames of image data received from another source of image data and corresponding to a different image.

Often, two panels are hingedly connected to one another so that the display device can be flipped open to reveal both panels. Generally speaking, there are two possible configurations. First, one panel may be flipped upwardly so that the two panels become disposed one above the other. This will be referred to as “vertically foldable.” Second, one panel may be flipped laterally, like a page in a book, so that the two panels come into a side-by-side disposition when the display device is flipped open. This will be referred to as “laterally foldable.” Exemplary vertically and laterally foldable configurations are shown in FIGS. 2A and 2B.

Where two panels are hingedly connected, the two panels may be employed to display the image data from a single provider of image data. First, where the display panels are provided in a vertically foldable configuration, a top half of the image is displayed on the upper panel and a bottom half of the image is displayed on the lower panel. Second, where the display panels are provided in the laterally foldable configuration, a left side of the image is displayed on one of the panels and a right side of the image is displayed on the other panel. In the vertically foldable configuration, the normal raster scan order of providing data to the two panels, i.e., row by row from top to bottom, corresponds to the order in which the data are presented to and displayed on the panels. However, in the laterally foldable configuration, since the data are stored in and retrieved from the memory in raster scan order, they are not organized for separate presentation to the respective display panels for display as right and left sides.

For example, to display a left-side of a first image frame on a left-most laterally foldable panel, the left-hand pixels of all rows of stored in the internal memory are first fetched and provided to the left-hand panel in raster order. After all of these data have been retrieved, the right-most pixels of all of the rows stored in the internal memory are fetched for provision to the right-hand panel in raster order. There is a problem, however, because while the left-most pixels of a first image frame are being fetched, new data corresponding to a next image frame are being stored in the internal memory. The fetching is faster than the rate that new data are stored, so the integrity of the left-hand data is maintained. However, by the time the graphics controller returns to the upper rows of the internal memory to begin fetching the right-hand data, at least some of these rows have been overwritten with the new data of a subsequent frame. Therefore, the right-hand panel receives image data corresponding to the first image frame which is mixed with image data corresponding to the next image frame, corrupting the displayed image.

This highly disadvantageous result may be avoided by “double buffering,” i.e., adding an additional frame buffer for storing the image data fetched from the internal memory. However, this solution to the problem is costly in chip real estate, system bandwidth, and power consumption. Therefore, there is a need for a graphics controller for displaying an image across laterally foldable display panels that avoids the need for double buffering.

### SUMMARY

In one embodiment, the invention is directed to an apparatus for displaying an image on a display device having at least two display panels. A preferred context for the invention includes a source that provides consecutive image frames, the frames comprising consecutive lines of the image data. In one embodiment, the apparatus is a graphics controller that interfaces between a source of image data and a display device.

In one embodiment, an apparatus according to the invention includes a memory and an image input module. The image input module is adapted for storing first line portions of lines of image data in a first contiguous portion of the memory for display on a first one of the display panels, and second line portions of the lines of image data in a second contiguous portion of the memory for display on a second one of the display panels. The first and second memory portions are preferably spaced apart by a third portion of the memory.

In another embodiment, an apparatus according to the invention includes a memory and a transfer module for reading first line portions of lines of image data from a first contiguous portion of the memory and for writing the first line portions to the display device for display on a first one of the display panels, and for reading second line portions of the lines of image data from a second contiguous portion of the memory and for writing the second line portions to the display device for display on a second one of the display panels before reading the next line.

This summary is provided for generally determining what follows in the drawings and detailed description. This summary is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 is a block diagram of a graphics display system comprising a host, a graphics controller according to one embodiment of the invention, a graphics display device, and a camera.

FIG. 2A is a pictorial view of a mobile telephone graphics display system employing a “flip-up” display device having at least two panels.

FIG. 2B is a pictorial view a preferred mobile telephone graphics display system employing a preferred laterally foldable embodiment of a display device having at least two panels.

FIG. 3A is a schematic illustration of an image frame provided to the graphics controller of FIG. 1.

FIG. 3B is a pictorial illustration of an image defined by the image frame of FIG. 3A.

FIG. 4A is a schematic illustration of an internal memory of the graphics controller of FIG. 1 showing a data storage organization according to one embodiment of the invention.

FIG. 4B is a schematic illustration of the internal memory of FIG. 4A showing an alternative data storage organization according to one embodiment of the invention.

FIG. 5 is a block diagram of a fetching module according to a “fetch data” aspect of an embodiment of the invention.

FIG. 6 is a block diagram of an image input module according to a “write data” aspect of an embodiment of the invention.

FIG. 7 is a table for use in protecting data stored in the graphics controller of FIG. 1 according to an embodiment of the invention.

### DETAILED DESCRIPTION

The invention relates to graphics display systems. In particular, the invention relates to a graphics controller for use in a graphics display system for displaying an image on laterally or vertically foldable display panels. In one embodiment, the graphics display system is a mobile telephone in which the graphics controller is disposed on a separate integrated circuit (“IC”) from the other principle elements of the system. It should be understood, however, that a graphics controller according to the invention may be used in other systems, and may be integrated into such systems as desired without departing from the principles of the invention. Moreover, the invention need not be embodied in a graphics controller or a separate IC. Reference will now be made in detail to specific preferred embodiments of the invention, examples of which are illustrated in the accompanying drawings. Wherever possible, the same reference numbers are used in the drawings and the description to refer to the same or like parts.

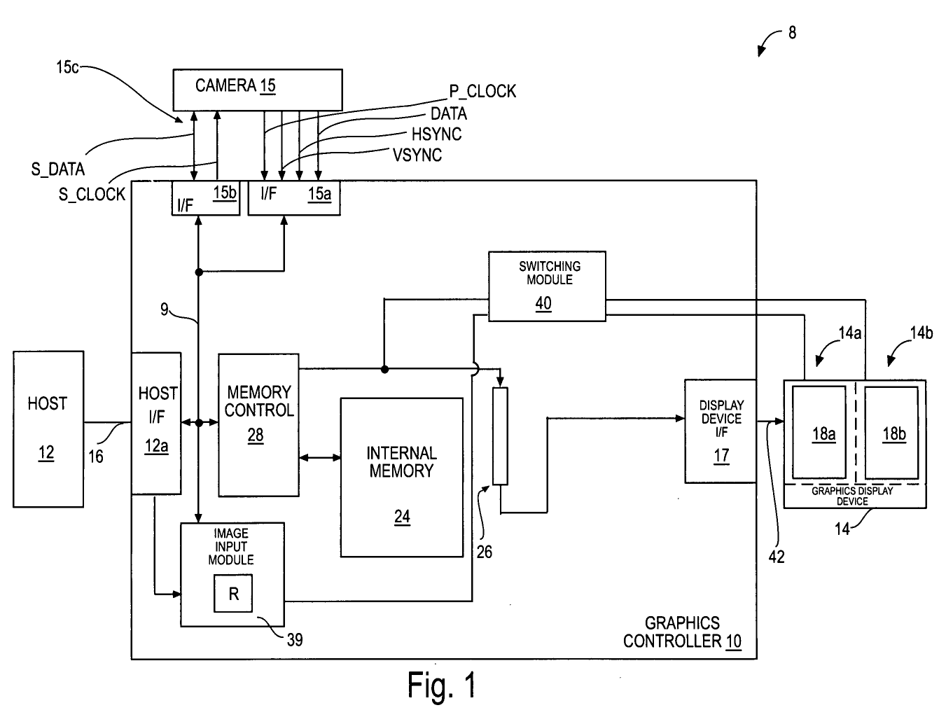

Referring to FIG. 1, a system 8 including a graphics controller 10 according to one preferred embodiment of the invention is shown. The system 8 may be any digital system or appliance providing graphics output; where it is a portable appliance such as a mobile telephone, it is powered by a battery (not shown). The system 8 typically includes a host 12, a camera module 15, and a graphics display device 14. The graphics controller 10 interfaces the host and camera with the display device. As mentioned above, the graphics controller is typically and preferably separate (or remote) from the host, camera, and display device.

The host 12 is preferably a microprocessor, but may be a digital signal processor, computer, or any other type of controlling device adapted for controlling digital circuits. The host communicates with the graphics controller 10 over a bus 16 to a host interface 12a in the graphics controller 10.

The camera module 15 acquires image data and provides the image data to the graphics controller 10 in addition to any image data provided by the host. The graphics controller 10 includes two interfaces for interfacing with the camera 15: a parallel, data interface 15a, and a serial, control interface 15b. The interface 15a provides for receiving transmitted image data (“DATA”) along with a clock signal (“P_Clock”), and vertical and horizontal synchronizing signals (“VSYNC” and “HSYNC”). The clock signal is used by the interface 15a, e.g., to determine when DATA are validly asserted. The serial interface 15b provides for transmitting control information (“S_Data”) to and from the camera 15 and transmitting a clock signal (“S_Clock”) to the camera 15. The bus 15c corresponding to the interface 15b is preferably that known in the art as an inter-integrated circuit (or I²C) bus. The data interface 15a and the control interface 15b are coupled to the host interface 12a and other components described below. As shown in FIG. 1, the interfaces are coupled in this embodiment by an internal bus 9.

To obtain maximum benefit from the invention, the graphics display device 14 includes at least two display panels 14a and 14b, having corresponding display areas 18a, 18b. The display panels 14a, 14b are adapted for displaying on their display areas pixels of image data. LCDs are typically used as display devices in mobile telephones, but any device(s) capable of rendering pixel data in visually perceivable form may be employed. Generally, the term “display panels” refers, as used herein, to any two or more distinct devices used for rendering pixel data.

Image data may originate from either or both the host 12 and the camera module 15 (hereinafter “source”). Image data may also originate from other sources. The image data are presented in frames (“image frames”) that each represent a single “snapshot.” Image frames received from the same source are typically related to one another for purposes herein. Where particular image data are associated with a particular frame, they may be referred to herein as an “image frame.”

Each image frame includes horizontal lines of image data. Each line of image data comprises individual pixels. The individual pixels of a line are ordered in a particular way for rendering part of a particular image. Sources typically send and the graphics controller typically receives pixels in raster order. Raster order refers to an arrangement in which pixels in a horizontal line are transmitted (or received) sequentially from the left to the right of the image and the lines are transmitted (or received) sequentially from the top to the bottom of the image. However, pixels may be transmitted (or received) in any predetermined order without departing from the principles of the invention. The image data are processed by, and transmitted to, the display device 14 through, the graphics controller 10.

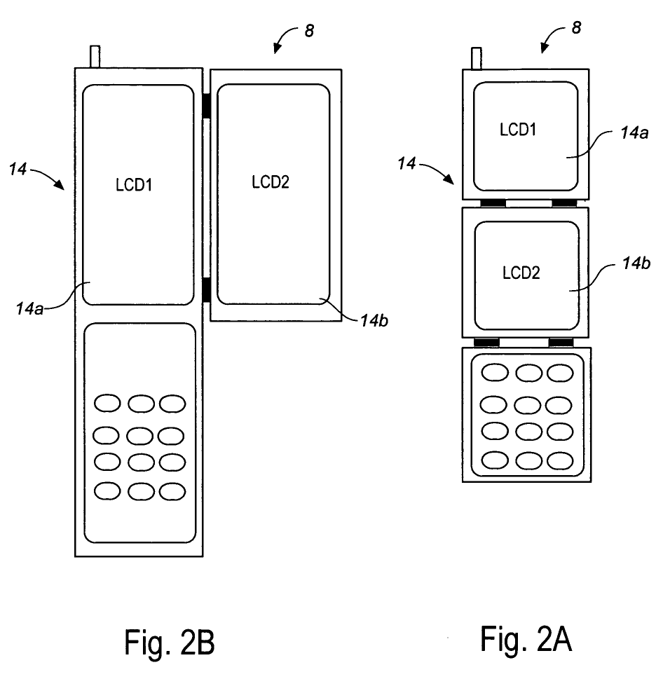

Referring to FIGS. 2A and 2B, the panels 14a and 14b may be placed in a vertically foldable configuration by flipping or un-folding the panels as shown in FIG. 2A, or laterally foldable configuration as shown in FIG. 2B. Additional panels may be used to assume combinations of these dispositions. While the graphics controller 10 (not visible in FIGS. 2A and B) may be used with display devices providing for any configuration, it is particularly adapted for use with display devices 14 having the laterally foldable configuration of FIG. 2B. In that configuration, in this example, the panel 14a is a left hand display panel relative to the panel 14b, which is a right hand display panel.

Referring back to FIG. 1, the graphics controller 10 further includes an internal memory 24 and associated memory controller 28, one or more display pipes 26, and a display device interface 17. Data provided by the host 12 and the camera module 15 are stored in the internal memory 24. The memory controller 28 is coupled to internal bus 9 and, among other things, controls access to the memory 24. The host defines how data received from the host and camera module are to be stored in the memory 24. The host allocates portions of the memory 24 for different purposes by instructing the graphics controller 10 through the host interface 12a.

The display pipe or pipes 26 fetch data stored in the internal memory 24 and write the data to the display device interface 17. Often separate display pipes are used to transmit different images to different panels, but to reduce costs a single pipe may also be used and time-shared between two separate data paths.

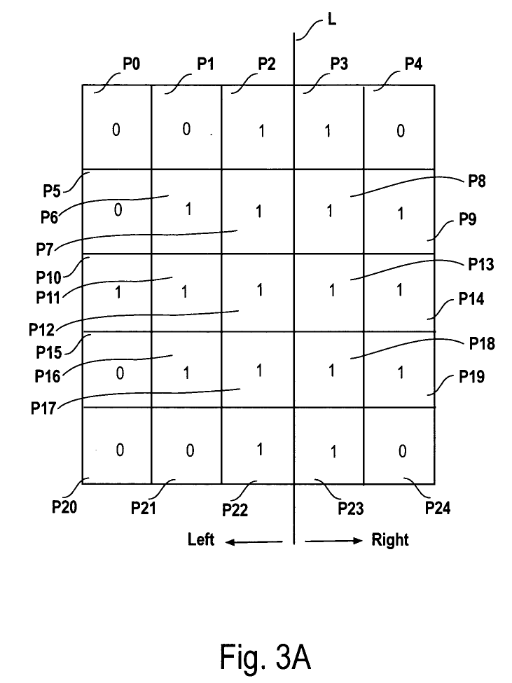

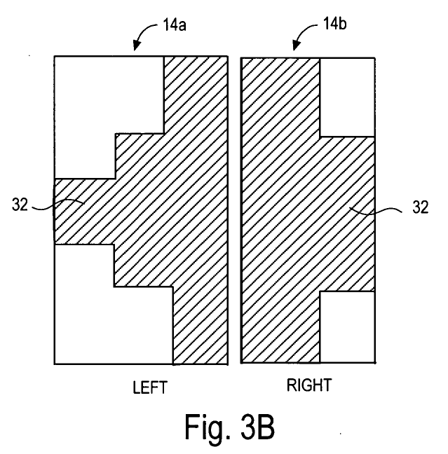

FIG. 3A illustrates a twenty-five pixel image frame 30 provided by a source. The image frame is received by the graphics controller 10 in a raster scan order; particularly, pixels P0-P4 are streamed consecutively from the source, followed consecutively by pixels P5-P9, etc., and ultimately followed by pixels P20-P24. It can be seen for FIG. 3A that the pixels on each line are ordered. Binary values of the pixels are indicated for illustration purposes. Actual values are typically 24 bits, though any particular number of bits is not critical. A image 32 corresponding to the image frame 30 is shown in FIG. 3B.

In this example, pixels to the left of the vertical line “L” correspond to a left-hand portion of the image 32 for display on the left hand panel 14a (see FIG. 2B) and pixels to the right of the line “L” correspond to a right-hand portion of the image for display on the right hand panel 14b. The image 32 is thereby conceptually divided into left and right halves. Each of the horizontal lines corresponding to the image is conceptually divided into left hand and right hand portions. The left hand portions of the lines are thereby associated with the left half of the image 32 and the right hand portions of the lines are associated with the right half of the image.

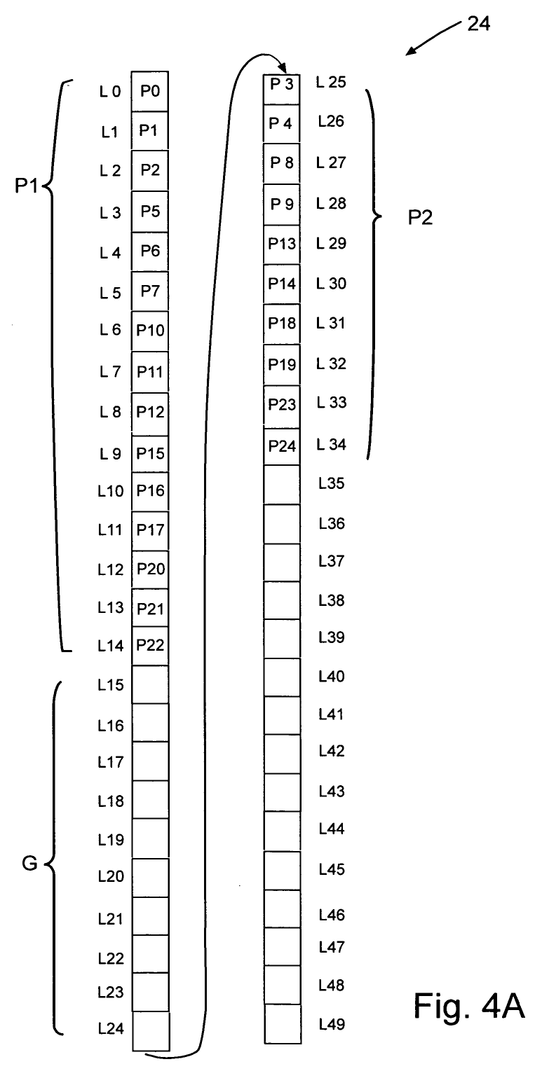

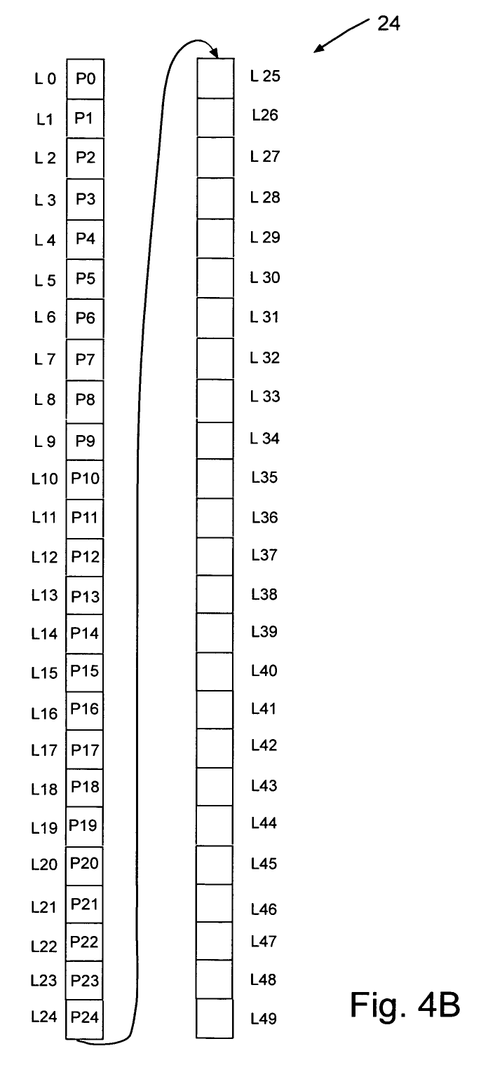

FIGS. 4A and 4B illustrate 50 individual pixel storage locations in the internal memory 24; particularly, locations L0-L49. The memory locations are shown in a linear, generic form for purposes of illustration; however, typically, the memory locations form a rectangular matrix. The memory locations of the memory 24 are “contiguous,” i.e., they are sequentially addressable without skipping any memory locations.

The image corruption problem caused as a result of a right-hand panel receiving image data of a first image frame which is mixed with the image data of the next image frame is solved by a novel manner of fetching the data from the memory 24 (“fetch aspect”). According to this fetch aspect, data from a single source may be written or stored in raster order to either one or two contiguous portions of the memory 24: P0-P24 as shown in FIGS. 4B or 4A, respectively. Similarly, the data are fetched from the memory in the same raster order. In other words, in each row of a scan line, the left-hand image and the right hand image are fetched at substantially the same time. As fetching progresses on to lower rows, new data may be written to upper rows that were previously accessed with no cross-frame image corruption. This is so even though the data correspond to a single image frame but are destined for display on different display panels. By contrast, ordinarily, image data from two sources destined for display on two different display panels corresponds to two different images so that the problem of cross-frame corruption does not arise.

Referring again to FIG. 1, the exemplary graphics controller also includes an image input module 39 and a switching module 40. The image input module 39 is coupled to the internal bus 9. The switching module 40 is coupled to the image input module. The switching module 40 is also coupled to the data path between the internal memory 24 and the display interface 17. In addition, the switching module 40 is coupled to the display device 14.

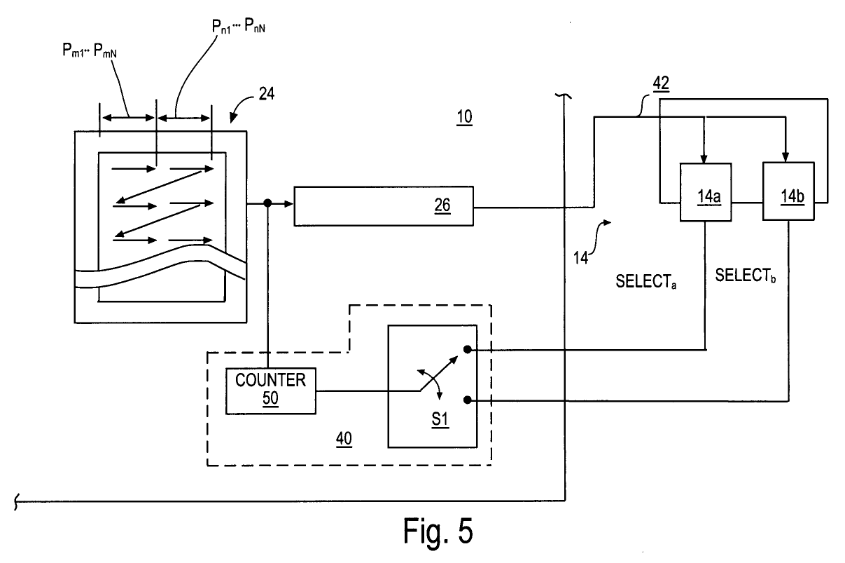

FIG. 5 illustrates one embodiment of a switching module 40 for implementing the fetch aspect in greater detail. As FIG. 3B shows, Pixels Pₘ₁-P_{mN} stored in the internal memory 24 correspond to the left-hand portion (“LEFT”) of the image 32, and pixels Pₙ₁-P_{nN} correspond to the right hand portion (“RIGHT”) of the image. Pixels are transmitted through a display pipe 26 to the display interface 17 for transmission on an output bus 42 to the display device 14. A switch S1 in the switching module 40 is used to select either the display panel 14a or the display panel 14b to receive the pixel data. The switching module 40 includes a counter 50 which counts pixels as they are transferred from memory to the display pipe 26. The switch S1 selects one of the panels based on, among other things, the value output by the counter 50. The switching module 40 functions so that the display panel 14a is selected to receive pixels corresponding to the left hand portion of the image, and the display panel 14b is selected to receive pixels corresponding to the right hand portion of the image. Many alternative ways of implementing the same functionality will be apparent to persons of ordinary skill. For instance, the counter 50 may monitor the output of the display pipe 26. Alternatively, the switching module 40 may monitor one or more signals, such as memory or pixel clock signals, or memory or image data signals. A state machine or combinational logic may be employed in place of the counter 50. Further, the switch S1 may be omitted in favor of logic for the assertion or de-assertion of one or more signals.

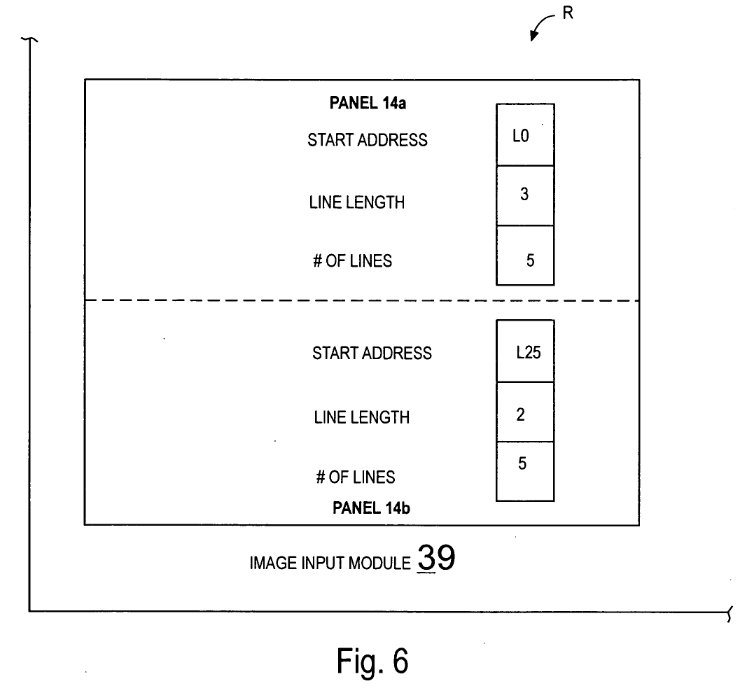

FIG. 6 shows the image input module 39 which includes a register set R that may be used by the switching module 40. To select one of two display panels 14a, 14b to receive particular data stored in the memory 24, a START ADDRESS register is provided for each of the panels that specifies the starting address in the memory where a first line of pixel data corresponding to, in this example, the respective left and right hand portions of the image 32 is stored, as indicated in FIG. 3A. In the example of FIG. 4A, START ADDRESS for the left hand image data is L0 and START ADDRESS for the right hand image data is L25.

A LINE LENGTH register is provided for at least one of the panels to specify the number of pixels to be selected from each line for one of the panels. Remaining pixels in each line may be assumed to be provided to the other panel; however, preferably, a LINE LENGTH register is provided for each panel. In the example of FIG. 3A, the left hand image data comprises line portions that are 3 pixels long (e.g., pixels P0, P1, P2 of the first line) and the right hand image data comprises line portions that are 2 pixels long (e.g., remaining pixels P3, P4 of the first line). A # OF LINES register is preferably provided for one or both display panels to indicate how many lines should be displayed on each panel. In the example of FIG. 3A, both the left and right hand portions have 5 lines. The counter 50 may be used in conjunction with the LINE LENGTH and # OF LINES registers for determining when to switch the output to another panel.

As will be readily appreciated, an offset register may be provided for specifying an offset for a line, e.g., if one or both halves of an image are to be cropped, and there can be a line-by-line specification of what data are to be selected for display on the panels, requiring any number of additional registers as desired. All of these specifications can be made in any desired manner; what is shown in FIG. 6 and described above is simply one illustrative example.

The registers in the register set R may be separate from the memory 24 or may be contained therein. Either the host 12 or the graphics controller 10, or the host and the graphics controller together, may write specifications to the register set R.

Turning now to a write aspect, recall that the data of FIG. 3A are written by a source to the memory 24 in the standard raster order, P0-P24. Typically, image data from a single source are stored in raster sequence in one distinct and contiguous portion of the memory 24, as shown in FIG. 4B. According to the write aspect, however, as the data are received in raster order, the image data are divided and stored in at least two distinct, contiguous portions of the memory 24, as shown in FIG. 4A.

Referring to FIG. 4A, the pixels P0-P2, P5-P7, . . . P20-P22 corresponding to the left hand portion (“LEFT”) of the image 32 (see FIG. 3B) are preferably stored in a first contiguous portion “P1” of the memory 24. Similarly, the pixels P3-P4, P8-P9, . . . P23-P24 corresponding to the right hand portion (“RIGHT”) of the image are preferably stored in a second contiguous portion “P2” of the memory. The memory portions “P1” and “P2” may, however, be advantageously spaced apart by a gap “G,” corresponding in this example to memory storage locations L15-L24, so that the two portions are not contiguous with each other.

In FIG. 4A, notice that the stored image data is arranged in a first raster order in memory portion P1 of the memory 24. Similarly, the stored image data is arranged in a second raster order in memory portion P2 of the memory 24. In particular, the memory portion P1 includes all of the left (or first) line portions. The phrase “first raster order” refers to proceeding from the top to the bottom first (or left) line portion, and left to right in within each first line portion. The phrase “second raster order” refers to proceeding from the top to the bottom second (or right) line portion, and left to right in within each second line portion.

In the example of FIG. 4A, the first (or left) line portions are 3 pixels while the second (or right) are 2 pixels. In other words, the first line portions comprise 60% of the width of the single image. Preferably, the first and second line portions are substantially equal, i.e., they each comprise about 50% of the width (or height) of the single image. However, this is not essential and other proportions are contemplated. For example, 75% and 25%.

The write aspect of the invention is advantageous in certain situations. For example, the system 8 may be operating in a mode where only one of the display panels 14a, 14b are active, say panel 14a. As such, one portion of the internal memory is allocated for storing image data for the panel 14a. Assume that locations L0-L14 are used for storing image data for panel 14a. While operating in this mode, the host allocates a second portion of the internal memory for storing “other” data. Assume that the host allocates L15-L24 for storing the other data and subsequently stores some data in these locations. Now assume that the mode of operation changes to one where both panels are active and a larger quantity of memory for storing image data must be allocated. For example, a single source begins sending more image data than will fit on a single panel and the image is for display on both panels. In the prior art, it would have been necessary to first move the other data from G to a third portion of memory so that the new image data could be stored in a single contiguous portion of memory. The write aspect of the invention is advantageous because it eliminates the need to move the other data to a third portion of memory.

Particularly, the write aspect of the invention permits the image to be split in the memory to avoid having to move other data that are or may be stored in the gap “G.” The register set R of the image input module 39 provides one convenient means for doing this. Left and right hand portions of an image may be stored in spaced-apart blocks “P1” and “P2” in the memory 24 simply by specifying a sufficiently spaced-apart START ADDRESS for each display panel to achieve, for example, the storage result shown in FIG. 4A.

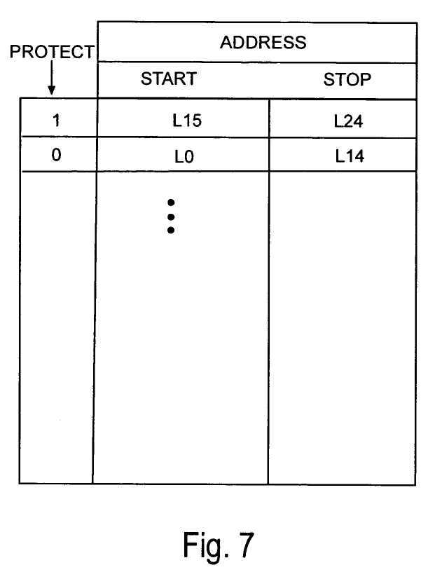

Alternatively, instead of specifying START ADDRESS locations, the gap G may be specified. Using this alternative, the host or graphics controller may specify locations in the memory 24 that are to be protected, and the graphics controller may dynamically re-allocate the START ADDRESS for one display panel or for each display panel as need arises and without host involvement, while maintaining the status of data stored in the protected area. A table such as that shown in FIG. 7 may be used to specify protected blocks of memory defined by a START and STOP address and, e.g., a PROTECT bit that is either high or low. Either the host 12, the graphics controller 10, or both, may write to the table which may reside in either or both the host and the graphics controller.

Preferably, the number of panels of a multi-panel display to be used for displaying an image is selectable. This panel selection aspect preferably incorporates a selection of one or both of the above-described write and fetch aspects. For example, it may be desirable to specify only one display panel for displaying a “preview” image obtained from the camera module 15, while the additional display space provided by one or more additional display panels may be necessary or desired for displaying “full frame” images of higher resolution, that is, a greater number of pixels. When displaying the preview image, the image is stored in and fetched from a first memory portion for display on a first display panel. When a selection is made for displaying the full frame across two panels, the image is stored in and fetched from first and second memory portions for display on first and second laterally foldable display panels. A register in the graphics controller accessible to the host may be used by the host to code for a selected one of a number of unique combinations of multiple panels across which an image is to be displayed as described above. For example, simply by setting a register value, the image data of a single image will be stored in either one contiguous portion of memory or two such portions. Similarly, by the setting the register value, for each row of a scan line of a single image stored in memory, the left-hand image and the right hand image will be fetched at substantially the same time.

It is to be recognized that, while a particular graphics controller for displaying an image across laterally foldable panels has been shown and described as preferred, other configurations and methods could be utilized, in addition to those already mentioned, without departing from the principles of the invention. In other embodiments, such as where the image data is presented to the graphics controller rotated 90° from the examples presented herein, the displaying an image across vertically foldable panels may be preferred.

It should also be understood that, while preferably implemented in hardware, the features and functionality described above could be implemented in a combination of hardware and software, or be implemented in software, provided the graphics controller is suitably adapted. For example, a program of instructions stored in a machine readable medium may be provided for execution in a processing device included in the graphics controller.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

We claim:

1. An apparatus for interfacing between a source of image data providing consecutive image frames and a display device having at least two display panels for displaying the image data, the frames comprising consecutive lines of ordered image data, the apparatus comprising:
a memory; and
an image input module adapted for storing:
first line portions of the lines of image data in a first contiguous portion of the memory for display on a first one of the display panels, and
second line portions of the lines of image data in a second contiguous portion of the memory for display on a second one of the display panels, wherein the first and second memory portions are spaced apart by a third portion of the memory.

2. The apparatus of claim 1, wherein the image input module is adapted for storing the first line portions in a first raster order and storing the second line portions in a second raster order.

3. The apparatus of claim 2, wherein each of the first line portions includes sequential image data of substantially one half of a corresponding one of the lines.

4. The apparatus of claim 1, wherein each of the first line portions includes sequential image data of substantially one half of a corresponding one of the lines.

5. The apparatus of claim 1, wherein the image input module includes a selectable capability for storing the second line portions in the first memory portion.

6. The apparatus of claim 1, further comprising a fetching module for fetching one of the first line portions from the first memory portion and fetching a corresponding second line portion from the second memory portion before fetching the next line.

7. An apparatus for interfacing between a source of image data providing consecutive image frames and a display device having at least two display panels for displaying the image data, the frames comprising consecutive lines of ordered image data, the apparatus comprising:
a memory for storing image frames; and
a transfer module for:
reading first line portions of the lines of image data from a first contiguous portion of the memory and for writing the first line portions for display on a first one of the display panels; and
reading second line portions of the lines of image data from a second contiguous portion of the memory, wherein the first and second memory portions are spaced apart by a third portion of the memory, and for writing the second line portions for display on a second one of the display panels before reading the next line.

8. The apparatus of claim 7, wherein the transfer module is adapted for reading the first line portions in a first raster order and reading the second line portions in a second raster order.

9. The apparatus of claim 8, wherein each of the first line portions includes sequential image data of substantially one half of a corresponding one of the lines.

10. The apparatus of claim 7, wherein the transfer module includes a selectable capability for reading the second line portions from the first memory portion.

11. A graphics display system, comprising:
a host;
a display device having at least two display panels;
an image data source for providing consecutive image frames, the frames comprising consecutive lines of ordered image data; and
an apparatus, the apparatus comprising:
a memory, and
a transfer module for:
reading first line portions of the lines of image data from a first contiguous portion of the memory and for writing the first line portions for display on a first one of the display panels; and
reading second line portions of the lines of image data from a second contiguous portion of the memory, wherein the first and second memory portions are spaced apart by a third portion of the memory, and for writing the second line portions for display on a second one of the display panels before reading the next line.

12. The system of claim 1 1, the apparatus further comprising an image input module adapted for storing the first line portions in the first memory portion, and for storing the second line portions in the second memory portion.

13. The system of claim 12, wherein the transfer module is adapted for reading the first line portions in a first raster order and reading the second line portions in a second raster order.

14. The system of claim 13, wherein the at least two display panels are hingedly connected to one another.

15. A method for interfacing with a display device having at least two display panels, comprising:
receiving consecutive image frames of image data, the image frames comprising consecutive lines of ordered image data;
storing first line portions of lines of a first image frame in a first contiguous portion of a memory for display on a first one of the display panels; and
storing second line portions of lines of the first image frame in a second contiguous portion of the memory for display on a second one of the display panels, wherein the first and second memory portions are spaced apart by a third portion of the memory.

16. The method of claim 15, further comprising:
fetching the first line portions for display on a first one of the display panels; and
fetching the second line portions for display on a second one of the display panels before transferring the next first and second line portions.

17. The method of claim 16, wherein the first line portions are fetched in a first raster order and the second line portions are fetched in a second raster order.

18. The method of claim 15, wherein the first line portions are stored in a first raster order and the second line portions are fetched in a second raster order.

19. The method of claim 18, wherein each of the first line portions includes sequential image data of substantially one half of a corresponding one of the lines.

20. The method of claim 15, wherein the second line portions of a second image frame are stored in the first memory portion.
